(19) United States
(12) Patent Application Publication
(10) Pub. No.: US 2012/0186930 A1
(43) Pub. Date: Jul. 26, 2012

(54) SUPPORTING AND DRIVING ASSEMBLY FOR A BLADE CARRIER DISC OF A ROTARY MULTIPLE-DISC MOWING MACHINE

(75) Inventors: Vincenzo Salvia, Rivarolo Canavese (IT); Vito Salvia, Rivarolo Canavese (IT)

(73) Assignee: GRIBALDI & SALVIA S.p.A., Torino (IT)

(21) Appl. No.: 13/497,223

(22) PCT Filed: Oct. 4, 2010
(86) PCT No.: PCT/IB10/54468

§ 371 Date: Mar. 20, 2012

(30) Foreign Application Priority Data
Oct. 5, 2009 (IT) TO2009A000753

(51) Int. Cl. A01D 69/06; F16D 13/38; A01D 34/76

(52) U.S. Cl. 192/66.31

(57) ABSTRACT

A hub (16) can be fixed to a blade carrier disc (11) and is mounted on a shaft (10) rotationally operated about a vertical axis. To transfer rotary movement from the shaft (10) to the hub (16) a plate (17) rotatable with the shaft and slidable along it is provided adjacent to the hub (16). A spring (19) pushes the plate towards the hub (16). The plate (17) and the hub (16) have corresponding interface surfaces which are inclined with respect to the axis of rotation or curved to convert movement of relative rotation between the hub (16) and the plate (17) into a relative separating movement in an axial direction. In a normal operating condition, the first and second interface surfaces are axially close and mutually engaged to transfer the rotary movement from the shaft (10) to the hub (16). Following an impact of the blades of the disc (11) with an external body, the first interface surfaces are disengaged from the second surfaces, axially spaced apart and angularly offset with respect thereto, so that the blade carrier disc and the hub are rotationally disengaged from the plate and the shaft.

The present invention relates to a supporting and driving assembly for a blade carrier disc of a rotary multiple-disc mowing machine. More particularly, the invention relates to a safety coupling system for the blade carrier discs.

Rotary multiple-disc mowing machines having a row of discs each with two or three blades, for example four to eight parallel-axis discs, are known, said discs being rotationally operated by a train of gears hermetically enclosed inside a casing with oil-bath lubrication. The blades, which are two or three in number for each disc, project radially or tangentially from the periphery of the discs. These discs are mounted along a bar or arm, spaced in a direction transverse to the mowing direction, so that the blades are rotatable in a plane generally parallel to the surface of the ground over which the mowing machine moves. The discs thus exert a mowing action along the entire length of the arm. The discs are spaced from each other so as to define free spaces between the periphery of the discs, and the rotation of the discs is synchronised so that the blades which project from each disc do not strike the blades of the adjacent discs while they rotate in the spaces between two adjacent discs.

Following accidental impact with stones, pieces of wood, cement articles, etc., which may be present on the ground, the blades may cause breakage of the transmission gears. In many cases the three transmission gears suffer extensive damage. This results in the need for repair with consequent long machine downtimes and high associated costs.

The safety systems proposed in the past consist in some cases of easy breakage points on the shaft which supports and rotationally drives the blade carrier disc, or easy breakage pins, in order to render the disc rotor idle and prevent damage to the transmission. In these cases also the mowing machine, however, is unusable until the damage parts have been replaced.

The object of the present invention is to prevent breakage of the gears following accidental impact and eliminate the drawbacks arising therefrom.

In order to achieve this object, together with other objects and advantages, which will be understood more clearly below, the invention provides a supporting and driving assembly for a blade carrier disc having the features defined in the accompanying claims.

A preferred, but non-limiting embodiment of the invention will now be described with reference to the accompanying drawings in which:

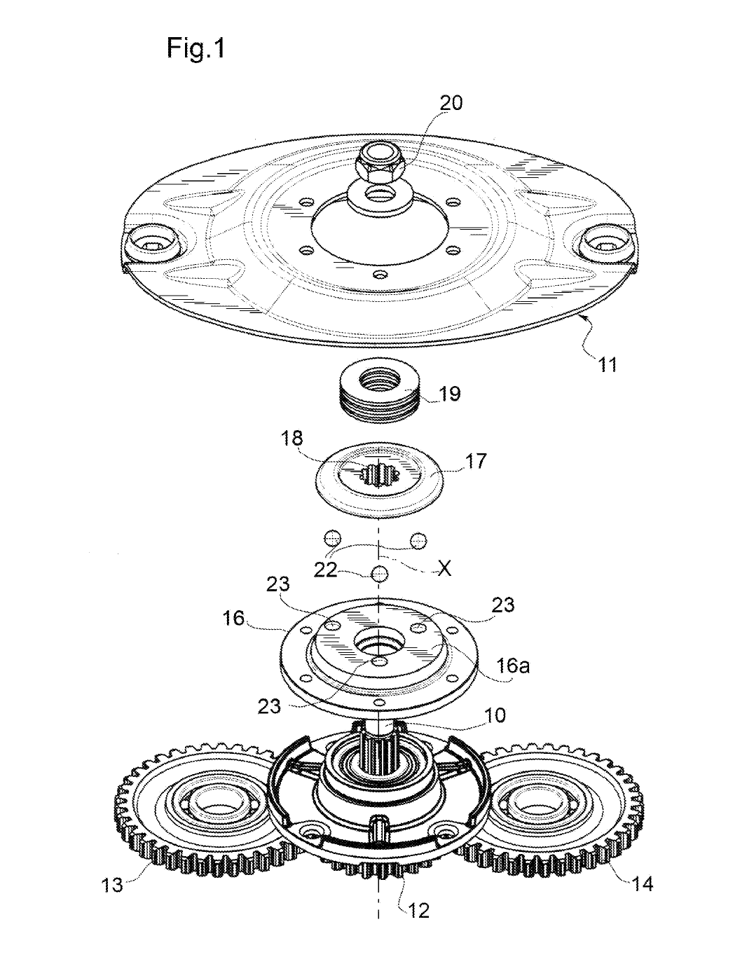

FIG. 1 is an exploded perspective view of a blade carrier disc and the associated rotary supporting and driving assembly;

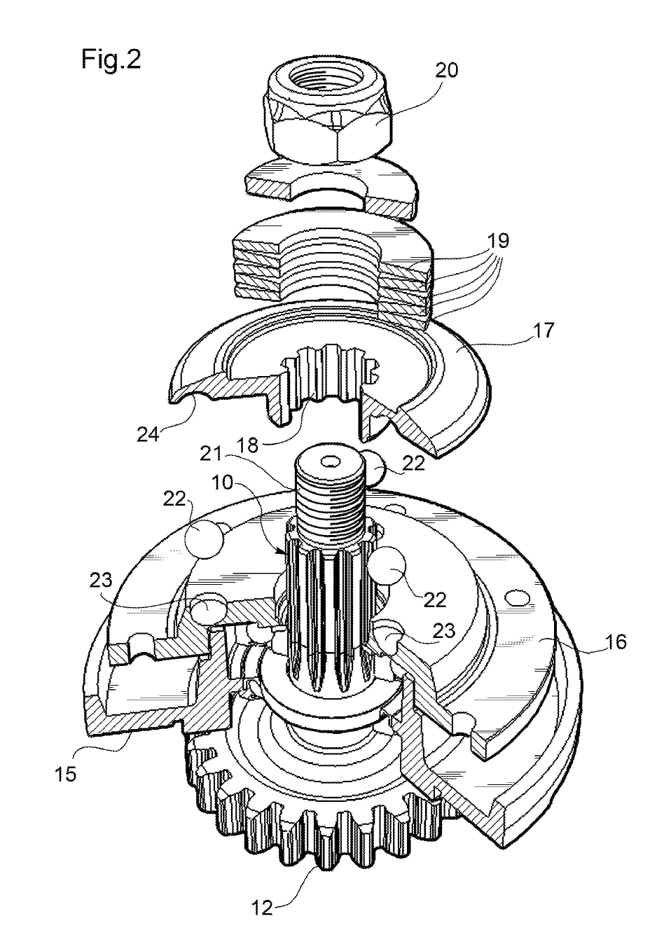

FIG. 2 is an exploded and partially cross-sectioned perspective view of the assembly according to FIG. 1;

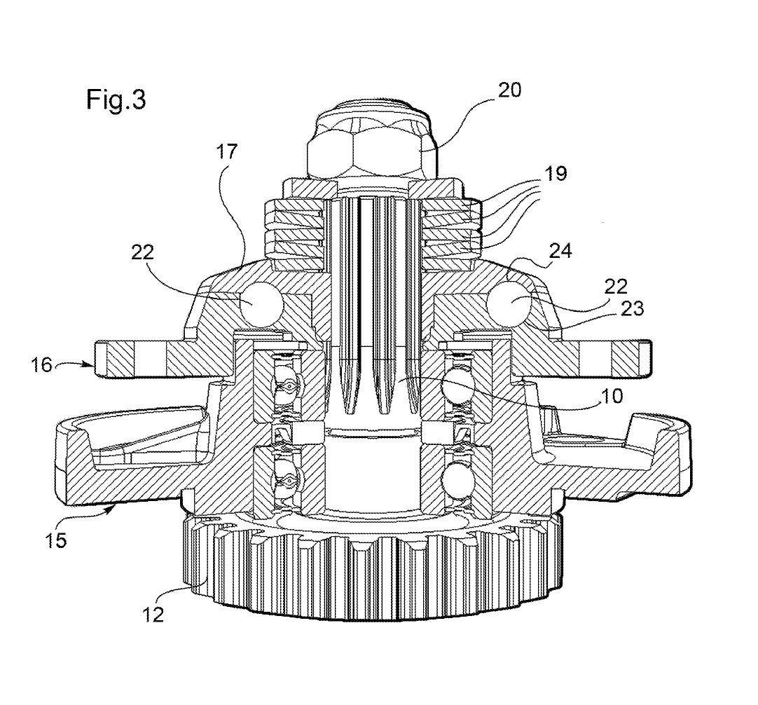

FIG. 3 is a view, along a vertical axial section, of the assembly according to FIG. 1 assembled in the normal operating condition (the blade carrier disc is not shown);

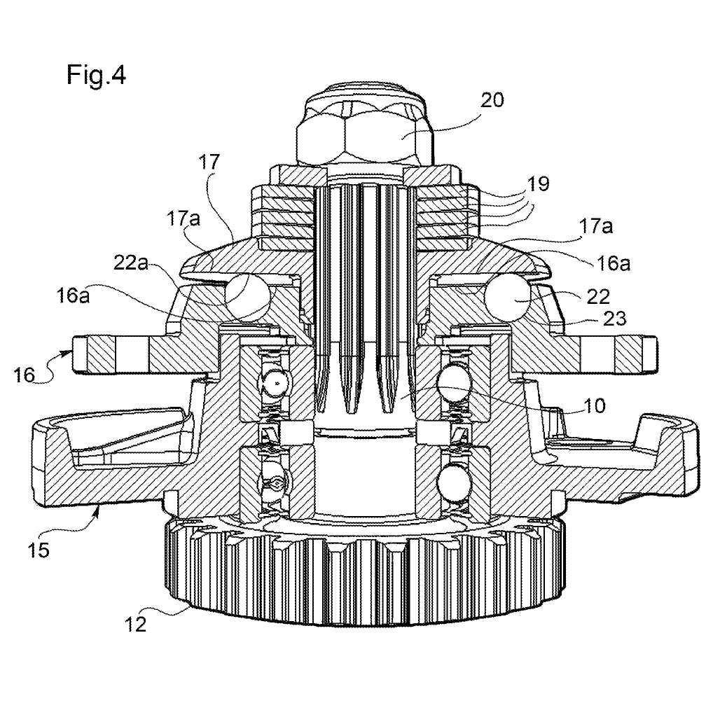

FIG. 4 is a view similar to that of FIG. 3, but shows the assembly in a different operating condition in which the blade carrier disc (not shown) is rotationally disengaged from its supporting and driving shaft.

With reference initially to FIGS. 1 to 3, the number 10 denotes an axially splined drive shaft which is able to support and rotationally drive a blade carrier disc 11 (the blades are not shown in the drawings). The shaft 10 receives the rotary movement about its axis via a gear wheel 12 or pinion which is formed as one piece or in any case fixed to one end of the shaft. The gear wheel 12 meshes with other gear wheels 13, 14 forming part of a gear train which, in a manner known per se, transmits the rotation to all the shafts and therefore to all the discs of the mowing machine.

The general configuration of a rotary multiple disc mowing machine of the type considered here and discussed in the introductory part of the present description is considered to be generally known. Consequently, in the remainder of this description, only the elements of specific importance and interest for the purposes of implementing the present invention will be described in detail. For the design of the parts and elements not shown in detail reference may therefore be made to a mowing machine of the known type.

The shaft 10 is mounted rotatably on a fixed support 15 about an axis x which is vertical during use. Throughout the present description and the claims, the terms and expressions indicating positions and orientation, such as “vertical”, are understood as referring to the condition when installed on the mowing machine during use. Thus, terms such as “axial” and “radial” must be interpreted with reference to the axis of rotation x.

The disc 11 is fixed to an annular disc-like hub 16 which is mounted with radial play on the shaft 10. The hub 16 is releasably coupled to a thrust plate 17 which preferably has an annular disc-like form and has an axially splined central opening 18 and is thus mounted slidably on the shaft 10. As a result of the splined coupling, the plate 17 is rotationally driven integrally with the shaft 10. One or more springs 19, in the example here a series of Belleville springs 19, elastically push the plate 17 axially towards the hub 16. The springs 19 are locked at the top by a nut 20 which is screwed onto the threaded top end 21 of the shaft 10.

The hub 16 and the plate 17 are adjacent in the axial direction. A series of balls 22 are provided at the interface between the hub and the plate, being mounted—in this example—on the hub 16 and projecting axially from the upper surface 16a of the hub itself. In the embodiment shown in the drawings, each ball 22 is accommodated inside a spherical seat formed by two complementary recesses 23, 24 which are facing and axially aligned and formed in the hub 16 and in the plate 17, respectively. The recesses 23 formed in the hub are niches shaped as a spherical segment having a spherical surface greater than that of a hemisphere, while the recesses 24 in the plate 17 have the shape of a spherical segment smaller than a hemisphere.

During normal operating conditions, the driving torque imparted by the shaft 10 is transmitted to the plate 17 and from the latter to the hub 16 via the balls 22 which are partially accommodated also inside the recesses 24 and exert against the latter a thrust in the circumferential direction (FIG. 3).

When one of the blades suffers an impact of a certain intensity which tends to stop the disc or slow down considerably its rotation, the hub 16 and the blade carrier disc 11 rotationally disengage from the shaft 10. In fact, owing to the effect of the resistive torque generated by the impact of the blade against an external body such as a rock, the portions of the balls projecting axially from the hub exert a thrust with an axial component against the recesses 24 of the plate 17. When this axial component exceeds the elastic force exerted by the springs 19, the latter compress, the plate 17 is raised and disengages the balls 22 from the recesses 24. In this condition (FIG. 4), the hub 16 and the disc 11 are idle with respect to the shaft 10; the bottom surface 17a of the plate rests against the top 22a of the balls and is kept in this contact condition by the springs 19.

It will be appreciated that the rotational disengagement of the blade carrier disc may take place without the breakage of any of the mowing machine components. It can also be appreciated that the blade carrier disc is automatically engaged again with the drive shaft 10. In fact, while the disc 11 and the hub 16 are disengaged, the plate 17 continues to be rotationally driven by the shaft 10; as soon as the recesses 24 pass over the balls 22, the springs extend and move the plate 17 towards the hub again. Engagement of the balls 22 inside the recesses 24 restores the transmission of the rotary movement from the shaft 10 to the blade carrier disc 11.

As shown more clearly in FIG. 1, in the preferred embodiment the balls 22 are positioned at different radial distances from the central axis of rotation, and the recesses 24 are distributed in the same configuration as the balls 22. Owing to this identical distribution, there is a single angular position of the hub 16 and the plate 17 in which each ball 22 is axially aligned with the respective recess 24 and therefore may be partially accommodated also inside the recesses 24 so as to receive from the plate 17 the thrust in the circumferential direction. That single angular position is suitably predetermined so that the blades of one disc do not interfere with the blades of the adjacent rotating disc. In other words, the various balls follow different circular trajectories about the axis of rotation and prevent the disc being locked in an angular position different from the predetermined position. The unique coupling system is such that the invention may be equally well applied to discs with two or three blades.

The projecting balls have dimensions and are distributed so as to define, in the disengaged condition described above (FIG. 4), a resting plane which keeps the hub oriented perpendicularly with respect to the axis of rotation. It is desirable in fact to prevent the hub from becoming excessively inclined with respect to the axis and therefore from seizing on the shaft during rotational disengagement and therefore remaining jammed on the shaft in an inclined position. Therefore the balls 22 are preferably three or more than three in number, are distributed angularly in a uniform manner around the axis of rotation and all have approximately the same projecting height with respect to the surface 16a so as to define a resting plane perpendicular to the axis of rotation.

The balls 22, once worn, may be replaced with a certain ease. The choice of using balls to form the protrusions 22 is a preferred, but not obligatory choice for the purposes of implementing the invention. In particular, the invention may be implemented by means of protrusions which have a shape different from a spherical shape, for example by means of projecting pins which are fixed or formed as one piece with the hub 16.

In an alternative embodiment, the protrusions may be carried by the plate 17 instead of the hub, in a configuration which is substantially the reverse of the example illustrated here.

According to another possible variant of the invention, the protrusions represented here by the balls 22 may consist of surfaces which are inclined with respect to the axis of rotation, for example three or more sawtooth surfaces, located at the interface between the plate 17 and the hub 16 and oriented so that, as a result of the engagement with respective corresponding surfaces, a movement of relative rotation between hub and plate is converted into a relative separating movement in an axial direction, parallel to or coinciding with that of the axis of rotation x.

It is understood that the invention is not limited to the embodiments described and illustrated here, which are to be regarded as examples of embodiments of the assembly. The invention, however, may be subject to modifications in terms of shape and arrangement of parts, as well as constructional and operational details. For example, the use of several Belleville springs is advantageous because it allows calibration of the threshold value for the resistance torque at which rotational disengagement of the blade carrier disc from the rotating shaft desirably occurs. Other elastic means may be used instead of the springs 19 illustrated here.

1. A supporting and driving assembly for a blade carrier disc of a multi-disc mowing machine comprising a row of rotary mower discs with parallel axes spaced apart along a supporting arm and driven for rotation by a gear train, the assembly comprising:
a shaft driven for rotation about an axis which is vertical in use;
a hub fixable to the disc and mounted onto the shaft;
mechanical connecting means for transferring rotary movement from the shaft to the hub;
wherein the connecting means include:
a member coupled for rotation with the shaft and axially slidably mounted along the shaft adjacent to the hub;
at least one elastic means mounted on the shaft for axially urging the member towards the hub;
first and second corresponding interface surfaces secured to the hub and the member, respectively, the surfaces being inclined with respect to the rotation axis or curved to convert a movement of relative rotation between the hub and the member into a relative bringing apart movement in an axial direction parallel to or coinciding with the rotation axis,
wherein the assembly is capable of reaching two alternative operational conditions:
a first normal working condition, in which the first and second interface surfaces are axially close and mutually engaged for rotation to transfer rotary motion from the shaft to the hub, and
a second condition, following an impact between one of the blades of the disc and an external body, in which the first interface surfaces are disengaged from the corresponding second interface surfaces, axially spaced apart and angularly offset with respect thereto, wherein the blade carrier disc and the hub are rotationally disengaged from the member and the shaft.

2. The assembly of claim 1, wherein the first and second interface surfaces include a plurality of protrusions carried by one of said hub and said member, and a corresponding plurality of recesses provided by the other of said hub and said member.

3. The assembly of claim 2, comprising at least three protrusions and at least three corresponding recesses, wherein the protrusions and the recesses are uniformly angularly spaced around the rotation axis.

4. The assembly of claim 2, wherein:
the protrusions are located at radially different distances with respect to the rotation axis,
the recesses are located at radially different distances according to an arrangement identical to that of the protrusions,
wherein a single angular position of rotational engagement between the hub and the member is defined, and wherein in said position each protrusion is axially aligned with a respective recess and is accommodated therein to transfer rotary motion form the member to the hub.

5. The assembly of claim 2, wherein the protrusions have all an approximately equal axial height to define a resting plane perpendicular to the rotation axis.

6. The assembly of claim 2, wherein the protrusions include balls.

7. The assembly of claim 6, wherein the balls protrude axially from a flat surface of the hub and, in the first, normal working condition, the balls are partially accommodated in recesses shaped as spherical segments obtained in a flat surface of the member.

8. The assembly of claim 7, wherein the balls are locked in recesses of the hub shaped as spherical segments having a spherical surface exceeding a spherical surface of a hemisphere.

9. The assembly of claim 1, wherein the member is a disc-like plate having an axially splined central opening, the member being slidably mounted on an axially splined portion of the shaft.
